(19) United States
(12) Patent Application Publication
(10) Pub. No.: US 2022/0348440 A1
(43) Pub. Date: Nov. 3, 2022

(54) DOOR FRAME FOR AN ELEVATOR SYSTEM

(71) Applicant: Inventio AG, Hergiswil (CH)

(72) Inventor: Romeo Lo Jacono, Gravesano (CH)

(21) Appl. No.: 17/754,063

(22) PCT Filed: Sep. 1, 2020
(86) PCT No.: PCT/EP2020/074274

§ 371 Date: Mar. 23, 2022

(30) Foreign Application Priority Data
Sep. 30, 2019 (EP) 19200507.2

(51) Int. Cl. B66B 13/30; B66B 11/00

(52) U.S. Cl. CPC B66B 13/306; B66B 11/002

(57) ABSTRACT

A door frame of an elevator system forms a chamber for accommodating a control unit and includes a first door frame element delimiting the chamber and having a first side closure extending in a straight line and a second door frame element delimiting the chamber and having a second side closure parallel to the first side closure. A fastening element extending along the side closures releasably fixes the first and second door frame elements together. The fastening element is arranged on the first and second door frame elements so as to be movable along the side closures and has a tool element for moving the fastening element from a locked position into a release position, wherein the first door frame element is fixed in the locked position on the second door frame element and can be removed from the second door frame element in the release position.

The invention relates to a door frame having a chamber for accommodating a control unit of an elevator system.

Elevator systems comprise an elevator car which can usually be moved vertically along an elevator shaft. The elevator car can accordingly be moved in such a way that it can be positioned at individual shaft doors such that access from the elevator car to the floor associated with the individual shaft door is provided. The elevator system further comprises a control unit which is required substantially for controlling the elevator system, in particular the movability of the elevator car. In addition, such a control unit can contain interfaces and input modules which are necessary for servicing the elevator system and for diagnostics.

This control unit can advantageously be arranged such that servicing the elevator system or the control unit can be carried out easily. Therefore, it is advantageous to arrange the control unit in a door frame of such a shaft door. Such a door frame is usually formed by a door lintel and a door post formed on each side of the door opening. To accommodate the control unit, the interior of one of these two door posts can form a chamber which is delimited by side walls of the door post.

EP1518815 discloses such a door post which is formed having a chamber. The interior of the chamber and thus the control unit can be reached from the floor by means of a flap which can be opened. A further opening in the door post is arranged such that maintenance can be carried out on the control unit from the inside of the elevator shaft. To carry out maintenance of the control unit, it is therefore necessary for the service technician to be in front of this opening. This can be achieved by placing the roof of the elevator car directly below this opening so that the service technician can carry out this maintenance from the roof of the elevator car.

Thus, the disadvantage is that the elevator car has to be arranged in the elevator shaft in such a way that the roof of the elevator car can be used as a work platform for servicing the control unit.

The problem addressed by the invention is therefore that of providing a door frame which allows improved access to a control unit which can be arranged in the door frame.

The problem is solved by a door frame of an elevator system comprising an elevator shaft, wherein the door frame forms a chamber for accommodating a control unit, the door frame comprising a first door frame element which delimits the chamber and has a side closure extending in a straight line, and a second door frame element which delimits the chamber and has a side closure parallel to the side closure of the first door frame element, and wherein the first door frame element can be fixed to the second door frame element by means of a fastening element which extends along the side closures and the fastening element is arranged on the first and second door frame elements so as to be movable along the side closures, and the fastening element has a tool element for moving the fastening element from a locked position into a release position, wherein the first door frame element is fixed in the locked position on the second door frame element and can be removed from the second door frame element in the release position.

The invention is based on the knowledge that access to the mechanism for fixing the door frame elements which delimit the chamber is crucial in order to allow maintenance to be carried out on the control unit quickly and easily. An arrangement of the elevator car at the floor provided with the door frame preferably on the landing door side so that an inner space of the elevator car is accessible from this floor is a possibility for substantially simplifying maintenance.

A prerequisite for this is that the first door frame element to be removed for maintenance can be removed if the inner space of the elevator car is arranged on the floor so that it is accessible. It is necessary that this first door frame element to be removed or the opening in the door frame resulting from the removal of the first door frame element is designed to be sufficiently large for carrying out maintenance of the control unit.

Two door frame elements can be connected to one another by a fastening element. This means that the first door frame element is fixed on the second door frame element by the fastening element in its locked position. The fastening element can be moved along the two side closures by means of the tool such that the lock can be released. The fastening element can advantageously be arranged in such a way that the tool can be pushed into a gap in the alignment between the door frame on the shaft door side and the elevator car, in particular a door frame of the elevator car, in order to unlock the fastening element to detach the door frame element. As a result of releasing this lock, i.e., the release position of the fastening element, the two door frame elements can be moved toward one another. This means that the first door frame element can be removed in such a way that the chamber within the door frame is accessible.

In a development of the door frame, the first door frame element has a second side closure extending in a straight line, and the door frame has a second fastening element for fixing the first door frame element on the second or a further door frame element, and the second door frame element has a second side closure or the further door frame element has a side closure and the second fastening element has a tool element for moving the second fastening element from a locked position into a release position, wherein the first door frame element is fixed in the locked position on the second or further door frame element and can be removed from the second or further door frame element in the release position.

This means that the removable first door frame element can be fixed, by means of the second fastening element on the second side closure of the first door frame element, on the second door frame element or the further door frame element of the door post forming the chamber. The technical features of the first or the second/further door frame element would accordingly be analogous to the previously described technical features for fastening the first to the second door frame element. This makes it possible for the first door frame element to be removed when the first and the second fastening element are arranged in their release position.

In a development of the door frame, the first door frame element has a second side closure extending in a straight line, and the door frame has a hinge extending along this second side closure associated with the first door frame element for fixing the first door frame element on the second or a further door frame element and the hinge is designed such that the first door frame element can be pivoted on the hinge. It is therefore possible for the first door frame element to release the chamber arranged in the door frame when the (first) fastening element is arranged in its release position by the first door frame element being pivotable into an open position about the axis of the hinge.

In a development of the door frame, the tool element is formed by an elevation or a depression or an opening, in particular by a pin or by a hole. By means of a tool element formed as an elevation, for example as a pin, which tool element projects outward from the door post above the plane of the door frame element, it is possible that a tool guided parallel to the door frame element which delimits the chamber can be used to transfer the fastening element from its locked position into its release position, and vice versa. In this way, fastening elements which are arranged between the shaft and car door posts can be actuated. By means of a recess or an opening, in particular a hole, the tool can be guided between the side closures of the first and the second door frame element arranged next to one another and inserted into the recess or the hole in order to transfer the fastening element from its locked position to its release position, or vice versa.

In a development of the door frame, the first door frame element has at least one docking element extending along the (first) side closure and the fastening element has a finger which can be associated with the at least one docking element in each case, wherein the docking element(s) and/or the finger(s) are angled or designed in such a way that the at least one docking element form-fittingly engages the finger which can be associated with the docking element in a locked position of the fastening element in order to prevent the first door frame element from being detached from the fastening element and the form fit can be lifted by moving the fastening element into its unlocked position, and the first door frame element can be detached from the fastening element in this way. It is advantageous that in a first position, the locked position, a first finger engages the docking element in such a way that the first door frame element is connected to the fastening element in a dimensionally stable manner By moving the fastening element, preferably along the main alignment of the door frame element, the fastening element can be moved in its unlocked position so that the first door frame element can be detached from the fastening element. Accordingly, the first door frame element can preferably be removed from the chamber manually

In a development of the door frame, the second door frame element, along its side closure, and/or the fastening element has or have a fold or folds in order to form-fittingly connect the second door frame element to the fastening element. It is advantageous that the fastening element is arranged movably on the second door frame element, but preferably cannot be removed. Correspondingly, the fastening element can be moved from its locked position into its unlocked position, or vice versa, while being retained.

In a development of the door frame, the side closures of the first and the second door frame element that can be connected by the fastening element face the elevator shaft and the pin protrudes into the elevator shaft. This makes it possible for the fastening element to be largely hidden from the elevator passenger, i.e., to be arranged facing away from the floor or the interior of the car and for the pin of the fastening element to be operated only by means of the tool. Thus, it is not obvious that this chamber arranged in the door frame can be opened, and therefore unintentional opening of the door frame can be prevented. Despite this advantage, it is, however, possible for the chamber of the door frame to be opened by moving the fastening element.

In a development, the door frame comprises a door post, which door post is intended to be arranged on the side of the door opening enclosed by the door frame, and the door post has the door frame elements. As a result, it is possible for the control unit which can be placed in the chamber to be arranged in its vertical height in such a way that maintenance can be carried out in a simple manner for the service technician, for example without necessarily having to carry out maintenance from a ladder.

In a development of the door frame, the side closure associated with the first door frame element and the side closure associated with the second door frame element are aligned vertically. By aligning the fastening element vertically, the door frame can be opened along a high, vertically aligned length. Correspondingly, the opening of the door frame for maintenance of the control unit can be large, which simplifies maintenance of the control unit.

In a development of the door frame, the first door frame element is formed by a corner element of the door frame. This means that the first door frame element preferably has an angled portion which is aligned in parallel with the side closure of said door element, preferably formed by an angle of 70° to 110°, preferably 90°, to form the corner element. Such an angled portion causes increased stability of the door frame element formed in this way such that the first door frame element does not have to have any additional reinforcements or reinforcement elements.

The invention is explained in greater detail below with reference to drawings, in which

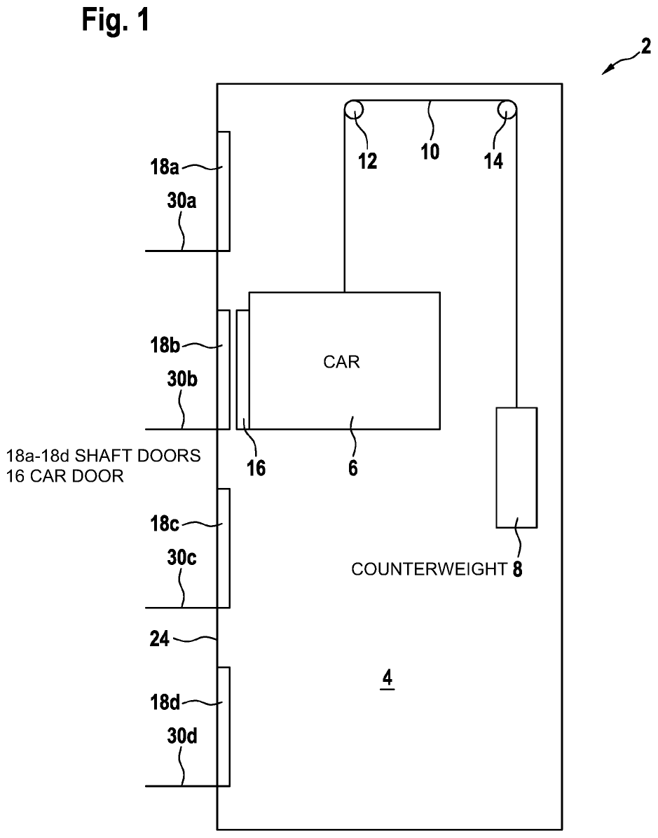

FIG. 1 shows an elevator system having a plurality of shaft doors;

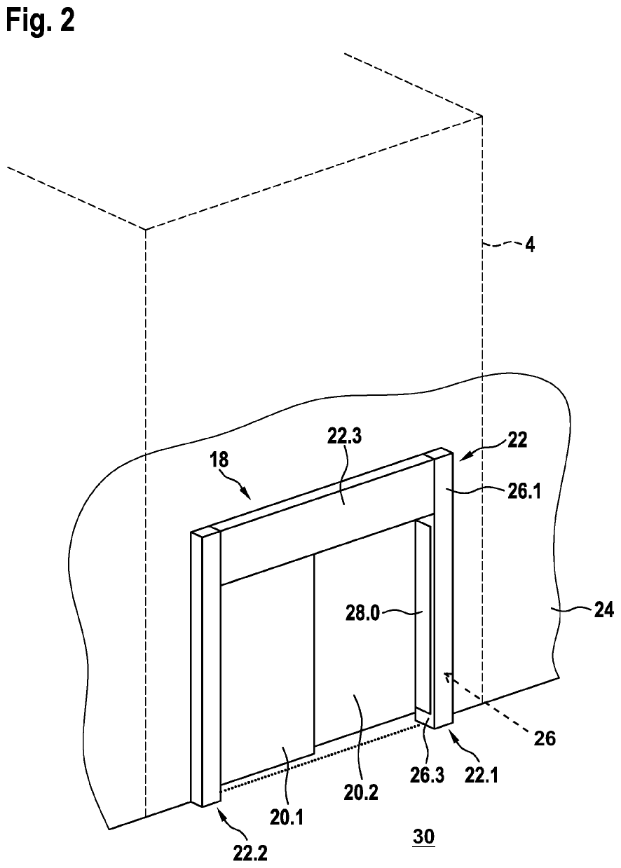

FIG. 2 shows one of the shaft doors having a door frame;

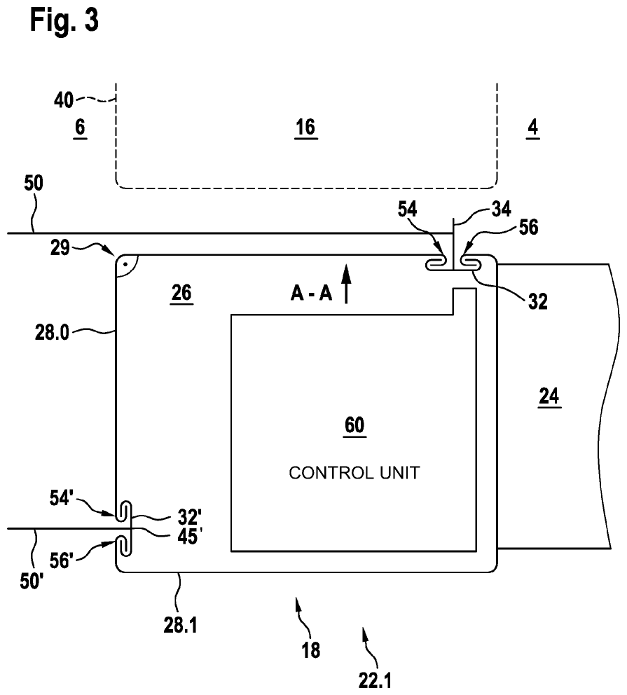

FIG. 3 shows a door post of the shaft door having an elevator car positioned at this shaft door in cross section;

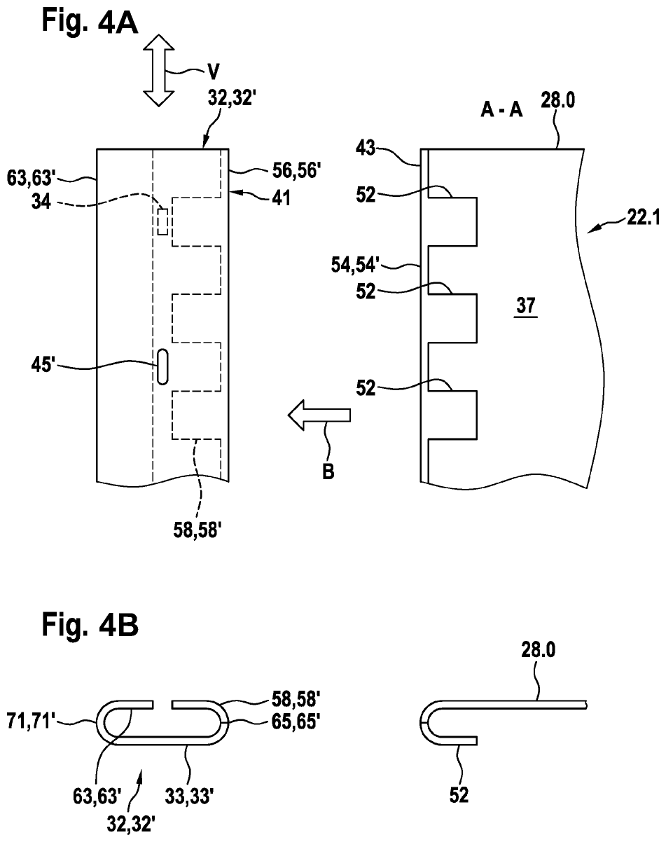

FIG. 4a shows the fastening element and the first door frame element to be fixed thereon according to a detail of FIG. 3; and

FIG. 4b shows the detail shown in FIG. 4a in cross section.

FIG. 1 shows an elevator system 2. The elevator system 2 is arranged in an elevator shaft 4. The elevator system 2 comprises an elevator car 6 which can be moved along the elevator shaft 4, a counterweight 8 which can be moved in the opposite direction to the elevator car 6, and a support element 10 which connects the elevator car 6 and the counterweight 8. The support element 10 can be guided over deflection rollers 12, 14, wherein one of these deflection rollers 12, 14 can be designed as a drive roller of a drive unit of the elevator system 2.

The elevator shaft 4 has a plurality of shaft door openings which are usually arranged vertically one above the other, wherein the shaft door openings allow access to the inner space of the elevator shaft at floors 30a, 30b, 30c, 30d. The shaft door openings are formed in a building wall 24.

A shaft door 18a, 18b, 18c, 18d which can be associated with the floor 30a, 30b, 30c, 30d is positioned at each of these shaft door openings. The elevator car 6 has a car door 16. This car door 16 or the elevator car 6 can be positioned at one of the shaft doors 18a, 18b, 18c, 18d by moving the elevator car 6 in the elevator shaft 4.

FIG. 2 shows a shaft door 18 positioned at one of these floors 30. The shaft door 18 substantially comprises a door frame 22 and at least one door leaf 20.1, 20.2, wherein the door opening can be closed and/or opened by means of the at least one door leaf 20.1, 20.2. The door opening is formed in a building wall 24, wherein this building wall 24 usually delimits the elevator shaft 4 on one side. The door frame 22 comprises two door posts 22.1, 22.2 and a door lintel 22.3. A first of the two door posts 22.1 is arranged on one side of the door opening, and the second of the door posts 22.2 is arranged on the other side of the door opening. The door lintel 22.3 is arranged above the door opening.

One of the two door posts 22.1, 22.2 or the door lintel 22.3 has a chamber. As an example, FIG. 2 shows that the chamber is arranged within one of the door posts 22.1. The door post 22.1 has walls 26.1, 26.3 which delimit the chamber.

FIG. 3 shows the door post 22.1 shown in FIG. 2 and comprising the chamber 26 in cross section, wherein the elevator car 6 is positioned at the shaft door 18 with which the door post 22.1 is associated. A control unit 60 is arranged within the chamber 26. The door post 22.1 has a first and a second door frame element 28.0, 28.1 which delimits the chamber 26, wherein the second door frame element 28.1 shown in FIG. 3 can be formed by a plurality of door frame elements. The first door frame element 28.0 and the second door frame element 28.1 can be fixed directly to one another by means of a first fastening element 32. The first door frame element 28.0 can be removed in such a way that the chamber 26 or the control unit 60 that can be arranged or is arranged in the chamber 26 is accessible to a service technician from the floor.

The removable first door frame element 28.0 is preferably designed as a corner element. The angled portion 29 shown in FIG. 3 leading to the formation of the corner element has a right angle. If necessary, the angle of the angled portion 29 can be configured differently from 90° in order to allow a different cross section of the door post 22.1 in accordance with customer-specific requirements.

The first door frame element 28.0 has a side closure 54 designed as a side edge and the second door frame element 28.1 likewise has a side closure 56 designed as a side edge. The side edges 54, 56 preferably extend in parallel and are slightly spaced apart from one another when the first door frame element 28.0 is fixed on the second door frame element 28.1 by the first fastening element 32. A door post 40 of the car door 16 belonging to the elevator car 6 is also shown by way of example in FIG. 3, wherein this elevator car 6 is positioned at the floor 18.

In the immediate vicinity of the first fastening element 32, the first and second door frame elements 28.0, 28.1 separate the chamber 26 from the inner space of the elevator shaft 4.

The first fastening element 32 comprises a tool element designed as a pin 34. For example, the pin 34 protrudes in the direction of the inner space of the elevator shaft 4 such that it is not directly accessible to elevator passengers when the elevator car 6 is positioned at the floor 18, since the pin 34 is arranged between the door posts 22.1, 40 of the elevator car 6 that are arranged on one side next to the door opening and the shaft door 18. By means of a ruler-like tool 50, which can be pushed into the gap between the door posts 22.1 of the car door 16 and the shaft door 18, the pin 34 of the fastening element 32 can be moved parallel to the edges 54, 56 of the first and the second door frame element 28.0, 28.1 such that the first door frame element 28.0 can be removed from the second door frame element 28.1. Optionally, as a result of this movement of the fastening element 32, the fastening element 32 may not be detachable from the second door frame element 28.1 in both its locked position and its release position, as will be explained in more detail at a later point in this description. The preferably rod-shaped fastening element 32 extends in its locked position along the alignment of this side edge 54.

The first door frame element 28.0 has a second side closure 54′ designed as a side edge. The first door frame element 28.0 can furthermore be fastened to the second door frame element 28.1 or to a further door frame element (not shown) of the door post 22.1 by means of a second fastening element 32′. The second or further door frame element 28.1 adjoining the first door frame element 28.0 has a side edge 56′ which is arranged directly parallel to the second side edge 54′ associated with the first door frame element 28.0 when the second fastening element 32′ is in its locked position.

Instead of connecting the first door frame element 28.0 to the second or further door frame element 28.1 by means of the second fastening element 54′, the first door frame element 28.0 can be connected to the second or further door frame element 28.1 by means of a hinge such that the first door frame element 28.0 can be pivoted into an open position when the first fastening element 54 is in the release position. In this open position of the first door frame element 28.0, the chamber 26 or the control unit 60 is accessible to a service technician. The hinge is preferably parallel to the side edges 54, 56.

If the first fastening element 32 is designed in such a way that it comprises the pin 34 and is designed as a corner element by forming the angled portion 29, it is advantageous that the second fastening element use a tool element which differs from a pin 34, since elevator passengers would have direct access to or view of this pin and thus the second fastening element 32′ could be easily transferred manually from its locked position to its release position. Instead of the pin 34, the tool element can accordingly be designed as a hole 45′ formed in the wall portion 33, 33′, which can be operated by a rod 50′ or a similar tool which fulfills the purpose. The second fastening element 32′ can be transferred from its locked position into its release position by means of the rod 50′, as is feasible with the first fastening element 32 by actuating the pin 34 by means of the tool 50.

FIGS. 4a and 4b show a fastening element 32, 32′ which can be formed by both the first and the second fastening element 32, 32′, and the first door frame element 28.0 according to a perspective A-A shown in FIG. 3 or in cross section. Since the second fastening element 32′ is designed largely the same as the first fastening element 32, only the arrangement (left/right) of the first fastening element 32 is shown in FIGS. 4a and 4b for the sake of simplicity. FIG. 4b is the view in cross section of a detail of FIG. 4a.

FIG. 4a shows the fastening element 32, 32′ at a distance from the first door frame element 28.0, i.e., unlocked. This means that the door post 22.1 or the chamber 26 of the door post 22.1 is open. The fastening element 32, 32′ can have a wall portion 33, 33′ and, for example, at least one finger 58. If the fastening element 32, 32′ has a plurality of these fingers 58, these fingers 58 are arranged along a side edge 65, 65′ of the fastening element 32, 32′. The fingers 58 can be shaped out of the plane of the wall portion 33, 33′ by a bent portion 41.

The first door frame element 28.0 has a flat surface 37 and, for example, docking elements 52. The docking elements 52 can be shaped out of the plane of the flat surface 37 by a bent portion 43. The docking elements 52 are arranged along the side edge 54 of the first door frame element 28.0. The flat surface 37 is formed by a wall which delimits the door post 22.1. In the locked position of the fastening element 32, 32′, the fingers 58 form-fittingly engage the docking elements 52 such that the first door frame element 28.0 is fixed on the second or further door frame element 28.1.

By moving the fastening element 32, 32′ in the V direction parallel to the side edges 54, 54′, 56, 56′ of the door frame elements 28.0, 28.1, the fastening element 32, 32′ can be moved from its locked position into its release position, and vice versa.

To transfer the first door frame element 28.0 into its locked position from its release position shown in FIG. 4a, 4b, the first door frame element 28.0 can be brought up to the fastening element 32, 32′ corresponding to a motion B in such a way that the fingers 58 of the fastening element 32 engage in the free spaces between the docking elements 52 of the first door frame element 28.0, wherein the fastening element 32, 32′ still assumes the release position in this position. Subsequently, by means of the movement of the fastening element 32, 32′ which can be carried out by means of the tool 50, 50′, the fingers 58, 58′ can thus be moved in such a way that the docking elements 52 exert the mechanical, form-fitting effect on the fingers 58, 58′, and the first door frame element 28.0 is fixed in this way. In the locked position of the fastening element 32, 32′ reached in this way, the fingers 58, 58′ form-fittingly engage the docking elements 52.

On the other side of the wall portion 33, 33′, the fastening element 32, 32′ can have a bent portion 71, 71′ along a second of its side edges 63, 63′ formed as an engaging element. For a form-fitting interaction of the fastening element 32, 32′ with the second or further door frame element 28.1, the second or further door frame element 28.1 can have such a bent portion. In the case of sufficiently pronounced bent portions of both the fastening element 32, 32′ and the second or further door frame element, this can mean that, regardless of whether the fastening element 32, 32′ is in its locked or release position, the fastening element 32, 32′ remains connected to the second or further door frame element 28.1.

The tool element of one of the fastening elements 32, 32′ is preferably designed as a pin 34 or as a hole 34′ for engaging the tool 50, 50′. As an alternative to this, the fastening element 32, 32′, as shown in FIG. 4a, can comprise a plurality of tool elements.

To transfer the first door frame element 28.0 into its locked position, the first door frame element 28.0 can be brought up to the fastening element 32 corresponding to a motion B in such a way that the fingers 58 of the fastening element 32 engage in the free spaces between the docking elements 52 of the first door frame element 28.0.

1-11. (canceled)

12. A door frame for a shaft door of an elevator system elevator shaft, wherein the door frame forms a chamber for accommodating a control unit of the elevator system, the door frame comprising:
a first door frame element having a first side closure extending in a straight line;
a second door frame element having another first side closure, the first side closures extending in parallel, the first door frame element and the second door frame element cooperating to delimit the chamber;
wherein the first door frame element is releasably fixed to the second door frame element by a fastening element that extends along the first side closures, the fastening element being arranged on the first and second door frame elements and being movable along the first side closures, the fastening element including a tool element for moving the fastening element from a locked position into a release position; and
wherein in the release position of the fastening element, the first door frame element can be removed from the second door frame element to access the chamber from outside the door frame.

13. The door frame according to claim 12 wherein the tool element is adapted to be operated by tool.

14. The door frame according to claim 13 wherein the tool element is formed as a pin.

15. The door frame according to claim 14 wherein the first side closures face the elevator shaft and the pin protrudes into the elevator shaft.

16. The door frame according to claim 12 wherein the fastening element is a first fastening element, the first door frame element has a second side closure extending in a straight line and the second door frame has another second side closure, the second side closures extending in parallel, a second fastening element releasably fixes the first door frame element on the second door frame element at the second side closures, the second fastening element having another tool element for moving the second fastening element from a locked position into a release position, and in the release position of the second fastening element, the first door frame element can be removed from the second door frame element to access the chamber from outside the door frame.

17. The door frame according to claim 16 wherein the another tool element is adapted to be operated by a tool.

18. The door frame according to claim 17 wherein the another tool element is formed as a hole in the second fastening element.

19. The door frame according to claim 12 wherein the first door frame element has a second side closure extending in a straight line, a hinge extends along the second side closure and fixes the first door frame element on the second door frame element, and the hinge allows the first door frame element to pivot relative to the second door frame element.

20. The door frame according to claim 12 wherein the first door frame element has a docking element extending along the first side closure and the fastening element has a finger adapted to engage the docking element, at least one of the docking element and the finger being shaped such that the docking element formfittingly engages the finger in the locked position of the fastening element to prevent the first door frame element from being detached from the fastening element, and moving the fastening element into the release position allows the first door frame element to be detached from the fastening element.

21. The door frame according to claim 12 wherein at least one of the second door frame element and the fastening element has a bent portion at the first side closure such that formfittingly connects the second door frame element to the fastening element.

22. The door frame according to claim 12 including a door post adapted to be arranged on a side of a door opening of the elevator shaft wherein the door post includes the first and second door frame elements.

23. The door frame according to claim 12 wherein first the side closure of the first door frame element and the first side closure of the second door frame element are aligned vertically.

24. The door frame according to claim 12 wherein the first door frame element is formed as corner element of the door frame.

25. A door frame for a shaft door of an elevator system elevator shaft, wherein the door frame forms a chamber for accommodating a control unit of the elevator system, the door frame comprising:
a first door frame element having a first side closure extending in a straight line;
a second door frame element having another first side closure, the first side closures extending in parallel, the first door frame element and the second door frame element cooperating to delimit the chamber;
wherein the first door frame element is releasably fixed to the second door frame element by a first fastening element that extends along the first side closures, the first fastening element being arranged on the first and second door frame elements and being movable along the first side closures, the first fastening element including a tool element for moving the first fastening element from a locked position into a release position;
wherein in the release position of the first fastening element, the first door frame element can be removed from the second door frame element to access the chamber from outside the door frame; and
wherein the first door frame element has a second side closure extending in a straight line and the second door frame has another second side closure, the second side closures extending in parallel, a second fastening element fixes the first door frame element on the second door frame element at the second side closures.

26. The door frame according to claim 25 wherein the second fastening element releasably fixes the first door frame element to the second door frame element, the second fastening element having another tool element for moving the second fastening element from a locked position into a release position, and in the release position of the second fastening element, the first door frame element can be removed from the second door frame element to access the chamber from outside the door frame.

27. The door frame according to claim 25 wherein the second fastening element is a hinge that allows the first door frame element to pivot relative to the second door frame element when the first fastening element is in the release position.
